(19) United States
(12) Patent Application Publication
(10) Pub. No.: US 2016/0368479 A1
(43) Pub. Date: Dec. 22, 2016

(54) SYSTEM AND METHOD FOR DRIVING MODE CONTROL OF HYBRID VEHICLE

(71) Applicant: Hyundai Motor Company, Seoul (KR)

(72) Inventors: Sang Joon Kim, Seoul (KR); Joonyoung Park, Seoul (KR)

(21) Appl. No.: 14/956,878

(22) Filed: Dec. 2, 2015

(30) Foreign Application Priority Data
Jun. 19, 2015 (KR) 10-2015-0087555

(51) Int. Cl. B60W 20/13; B60W 30/14; B60W 20/40; B60W 10/26; B60W 10/06; B60W 10/08

(52) U.S. Cl. CPC B60W 20/13; B60W 10/06; B60W 10/08; B60W 20/40; B60W 10/26; B60W 30/14; B60W 2540/10; B60W 2710/244; B60W 2710/083; B60W 2710/0666; B60W 2600/00; Y10S 903/93

(57) ABSTRACT

A driving mode control system of a hybrid vehicle includes a driving information detecting unit which detects information of manipulation of an accelerator pedal by a driver and an operating state of an electric load, a second motor which generates a starting torque in accordance with a control signal which converts a driving state into a hybrid electric vehicle (HEV) mode to start the engine, and a hybrid controller which calculates a system demand power by a sum of a driver demand power which is calculated by a mapping value by the accelerator pedal manipulation information and the electric load demand power in accordance with the operating state of the electric load to determine a time to connect the engine power in accordance with a predetermined reference value setting.

### CROSS-REFERENCE TO RELATED APPLICATION

This application claims under 35 U.S.C. §119(a) the benefit of Korean Patent Application No. 10-2015-0087555 filed in the Korean Intellectual Property Office on Jun. 19, 2015, the entire contents of which are incorporated herein by reference.

### BACKGROUND

(a) Field of the Invention

The present invention relates to a driving mode control system of a hybrid vehicle and a method thereof.

(b) Description of the Related Art

Generally, in accordance with enhanced fuel efficiency requirements of vehicles and consolidation of regulations of exhaust gas in each country, a demand for environmentally-friendly vehicles has increased, and a hybrid vehicle (hybrid electric vehicle/plug-in hybrid electric vehicle: HEV/PHEV) is provided as a practical alternative.

The hybrid vehicle may provide an optimal output torque by efficiently operating an engine and a motor as two power sources of the hybrid vehicle.

That is, a driving mode of the hybrid vehicle includes an electric vehicle (EV) mode by electric power and an HEV mode which drives the vehicle using two or more power sources such as the engine and electric power. Further, in the hybrid vehicle, it is very important to determine a time to convert the EV mode into the HEV mode in order to achieve drivability of a vehicle and enhancement of fuel efficiency.

A driving mode converting method of a hybrid vehicle of the related art and a problem thereof will be described with reference to FIGS. 1 and 2.

FIG. 1 (RELATED ART) is a graph illustrating a time to determine EV-HEV mode conversion according to a first method of the related art.

Referring to FIG. 1, in the related art, in order to determine an EV-HEV mode, a demand torque by a driver is monitored and calculated and when the demand of the driver exceeds a predetermined torque reference value (threshold), the mode is shifted into an HEV mode to connect power of the engine to a drive shaft. That is, according to the first method of the related art, only when the demand of the driver in the EV mode exceeds a predetermined torque reference value (threshold), the mode is converted into the HEV mode.

However, like the first method of the related art, when the single driving mode converting reference value is used, if the vehicle is continuously driven with a low driver demand, the battery may be over-discharged.

FIG. 2 (RELATED ART) is a graph illustrating a time to determine an EV-HEV mode conversion according to a second method of the related art.

Referring to FIG. 2, in the second method of the related art, a demand torque of the driver is defined by a first high torque reference value (first threshold) and a second low torque reference value (second threshold) to convert the mode by utilizing these two values (i.e., in two steps).

First, when the demand torque of the driver of the hybrid vehicle exceeds the first high torque reference value, the mode is immediately converted into the HEV mode to connect the engine power.

Further, when the demand torque of the driver exceeds the second low torque reference value, the hybrid vehicle drives the engine after a predetermined time t1 elapses in a state where the demand torque exceeds the second torque reference value.

However, in the second method of the related art, driving energy by the EV mode is not exactly reflected so that it is difficult to determine the predetermined time t1 and the reference value is determined using the torque so that it is not efficient to manage the high voltage battery.

The above information disclosed in this Background section is only for enhancement of understanding of the background of the invention and therefore it may contain information that does not form the prior art that is already known in this country to a person of ordinary skill in the art.

### SUMMARY

The present invention provides a driving mode control system and method of a hybrid vehicle enabling control conversion from an EV mode into a HEV mode to connect an engine power of a hybrid vehicle using a driver demand power and a system demand power considering a demand power of an electric load system of the vehicle.

An exemplary embodiment of the present invention provides a driving mode control system of a hybrid vehicle including a driving information detecting unit which detects information of manipulation of an accelerator pedal by a driver when the hybrid vehicle moves and an operating state of an electric load, a second motor which generates a starting torque in accordance with a control signal which converts a driving state into a hybrid electric vehicle (HEV) mode to start the engine, and a hybrid controller which calculates a system demand power by a sum of a driver demand power which is calculated by a mapping value by the accelerator pedal manipulation information and the electric load demand power in accordance with the operating state of the electric load to determine a time to connect the engine power in accordance with a predetermined reference value setting, in which when the system demand power exceeds a set upper limit power reference value (P-threshold 1), the hybrid controller controls to convert a driving mode into the HEV mode, and in a low power demand condition where the system demand power exceeds a lower limit power reference value (P-threshold 2), when an accumulated demand energy in which the system demand power is accumulated exceeds a predetermined energy reference value (E-threshold), convert the driving mode into the HEV mode.

The driving mode control system of a hybrid vehicle further includes an inverter which drives a first motor and a second motor which convert a DC voltage supplied from a battery into an AC voltage to generate a driving torque, a battery management unit which manages a state of charge (SOC) of the battery, and an engine controller which controls the engine torque in accordance with a command of the hybrid controller and monitors an operating state of the engine to transmit the operating state to the hybrid controller.

Further, when the vehicle is feedback controlled by cruise control, the hybrid controller may calculate the driver demand power in consideration of a demand torque which is input for automatic navigation control and a rotation speed of a drive shaft.

In addition, the hybrid controller may multiply a weighting factor for every state of charge (SOC) of the battery and consumption power of electric equipment in the vehicle including at least one of an air conditioner, a heater, an AVN, and an LDC to calculate the electric load demand power.

Further, the weighting factor for every SOC of the battery may vary the system demand power such that when the SOC of the battery is low, the system demand power is low and when the SOC is high, the system demand power is high.

In addition, the hybrid controller may set the upper limit power reference value in consideration of an SOC of the battery, a maximum available power of the battery, and an available power of the first motor to set the upper limit power reference value and determine a minimum value among multiple upper limit power reference values as a final upper limit power reference value (P-threshold 1).

Further, when the hybrid controller sets the upper limit power reference value in consideration of the SOC of the battery, the hybrid controller may variously set the reference value to be low as the current SOC state is low and set the reference value to be high as the SOC is high.

In addition, the available power of the battery may be set in consideration of a battery temperature in accordance with a battery hardware specification, an SOC, and a margin for protecting a battery and the available power of the first motor may be set in consideration of a motor inverter temperature in accordance with a hardware specification of the first motor and a margin for protecting the first motor.

Further, the lower limit power reference value may be set by varying the set value in accordance with the SOC of the battery and set to be lower than the upper limit power reference value in consideration of the SOC.

In addition, the lower limit power reference value may be mainly set based on a time when the accelerator pedal is pressed at an angle which is smaller than a predetermined angle of a light tip in (LTI).

Further, the accumulated demand energy may be a value which is accumulated while the exceeded state is maintained from a time when the system demand power exceeds the lower limit power reference value (P-threshold 2).

In addition, the energy reference value may be set by varying the set reference value to be small when the SOC of the battery is small and to be high when the SOC is high.

Another exemplary embodiment of the present invention provides a driving mode control method of a hybrid vehicle which is driven in an electric vehicle (EV) mode in which a reference value for starting an engine is set by two values, for example, an upper limit power reference value (P-threshold value 1) and a lower limit power reference value (P-threshold 2), the method including a) calculating a system demand power by a sum of a driver demand power calculated by a mapping value by accelerator pedal manipulating information of a driver and an electric load demand power in accordance with an operating state of an electric load; b) controlling the driving mode to be converted into a hybrid electric vehicle (HEV) mode when the system demand power exceeds the upper limit power reference value (P-threshold 1); or c) accumulating the system demand power in a low power demand condition where the system demand power is smaller than the upper limit power reference value but exceeds the lower limit power reference value (P-threshold 2); and d) controlling the driving mode to be converted into the HEV mode when the accumulated demand energy in which the system demand power is accumulated exceeds a predetermined energy reference value (E-threshold).

Further, before step a), the method may further include determining the smallest value among a first upper limit power reference value (P-threshold a) set in accordance with the charging state (SOC) of a battery, a second upper limit power reference value (P-threshold b) set in accordance with a maximum available power of the battery system, and a third upper limit power reference value (P-threshold c) set in accordance with the maximum available power of the first motor as a final upper limit power reference value (P-threshold 1) and setting the lower limit power reference value in accordance with the SOC of the battery, to be lower than the first upper limit power reference value in consideration of the SOC.

According to the exemplary embodiment of the present invention, when a hybrid vehicle is continuously driven in a low driver demand condition, the mode is converted into an HEV mode in accordance with accumulation of a system demand power, thereby preventing a high voltage battery from being over-discharged.

Further, differently from the related art that simply determines whether a low demand torque exceeds a predetermined reference time, in the present invention, it is determined whether to start the engine based on a practical demand energy amount so that it is advantageous for SOC balancing of the high voltage battery.

### BRIEF DESCRIPTION OF THE DRAWINGS

FIG. 1 (RELATED ART) is a graph illustrating a time to determine EV-HEV mode conversion according to a first method of the related art.

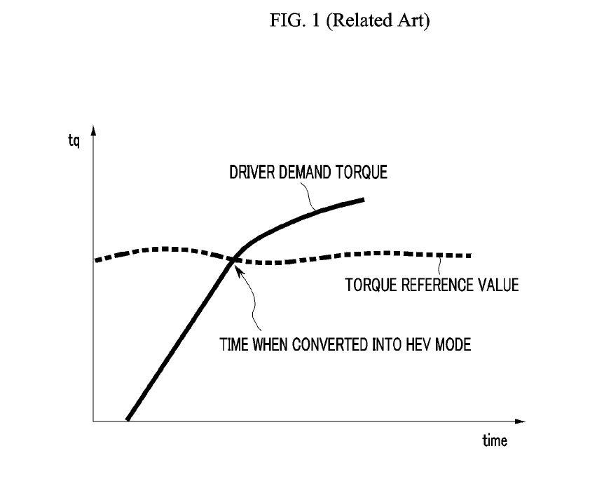

FIG. 2 (RELATED ART) is a graph illustrating a time to determine EV-HEV mode conversion according to a second method of the related art.

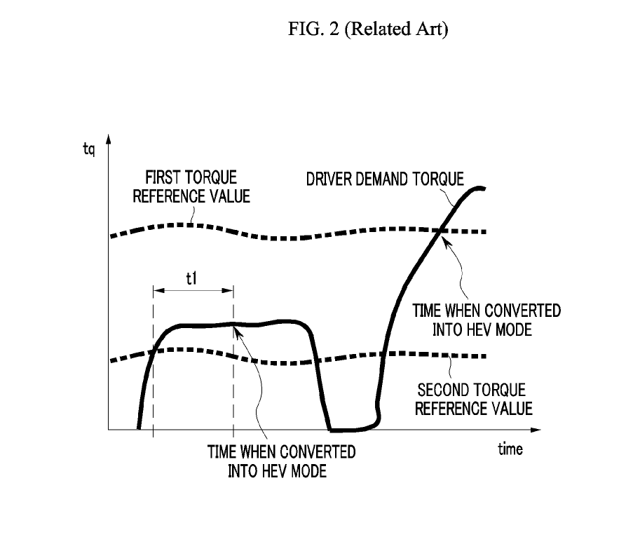

FIG. 3 is a block diagram schematically illustrating a driving mode control system of a hybrid vehicle according to an exemplary embodiment of the present invention.

FIG. 4 is a graph illustrating a method of calculating a system demand power according to an exemplary embodiment of the present invention.

FIG. 5 is a graph illustrating a time to convert EV-HEV mode according to an exemplary embodiment of the present invention.

FIG. 6 is a flowchart illustrating a method for setting an upper limit power reference value according to an exemplary embodiment of the present invention.

FIG. 7 is a flowchart illustrating a method for setting a lower limit power reference value according to an exemplary embodiment of the present invention.

FIG. 8 is a flowchart illustrating a driving mode control method of a hybrid vehicle according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Now, a driving mode control system of a hybrid vehicle according to an exemplary embodiment of the present invention and a method thereof will be described in detail with reference to the drawings.

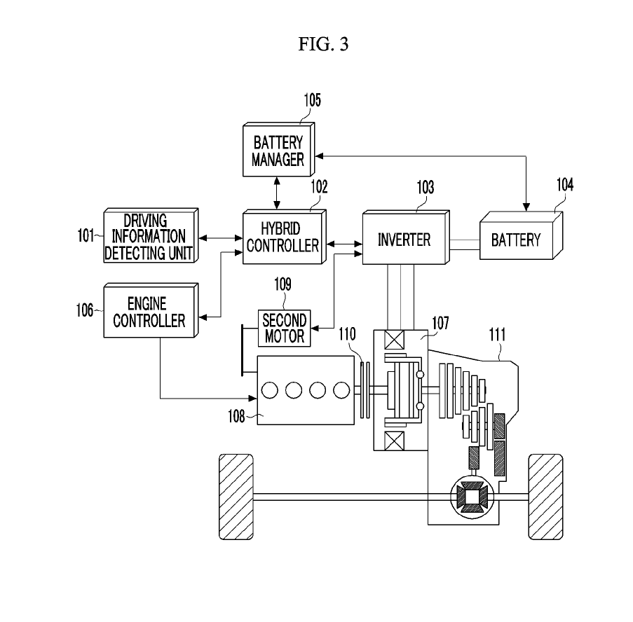

FIG. 3 schematically illustrates a driving mode control system of a hybrid vehicle according to an exemplary embodiment of the present invention.

Referring to FIG. 3, a driving mode control system of a hybrid vehicle according to an exemplary embodiment of the present invention includes a driving information detecting unit 101, a hybrid controller 102, an inverter 103, a battery 104, a battery manager 105, an engine controller 106, a first motor 107, an engine 108, a second motor 109, an engine clutch 110, and a transmission 111.

The driving information detecting unit 101 detects information in accordance with driving of the hybrid vehicle including a vehicle speed, a gear, a displacement of an accelerator pedal (APS), a displacement of a brake pedal (BPS), and an operating state of electric loads and provides the information to the hybrid controller 102.

The hybrid controller 102 is a top level controller of the hybrid vehicle and collectively controls controllers which are connected by a network, determines EV-HEV mode conversion and controls the torque.

Particularly, the hybrid controller 102 calculates the system demand power by sum of the driver demand power and a demand power (hereinafter, referred to as an electric load demand power) of the electric load system in the vehicle including an air conditioner, a heater, an AVN, and an LDC to utilize the system demand power at a time when an engine power is connected, which will be described in detail below.

The inverter 103 is configured by a plurality of power switching elements and converts a DC voltage which is supplied from the battery 104 into a three phase AC voltage in accordance with a control signal applied from the hybrid controller 102 to drive the first motor 107 and the second motor 109.

The power switching elements which configure the inverter 103 may be configured by any one of an insulated gate bipolar transistor (IGBT), a MOSFET, a transistor, and a relay.

The battery 104 is configured by a plurality of unit cells and a high voltage which is supplied to the first motor 107, for example, voltage of DC 400 V to 450 V may be stored in the battery 104.

The battery manager 105 detects a current, a voltage, and a temperature of the cells in an operating area of the battery 104 to manage the state of charge (SOC) and controls a charged and discharged voltage of the battery 104 to prevent the battery from being over-discharged to be below a limited voltage or overcharged to be over the limited voltage to shorten a lifespan.

The engine controller 106 controls a torque of the engine 108 in accordance with a command of the hybrid controller 102 and monitors operating statuses of the engine to transmit the operating status to the hybrid controller 102.

The first motor 107 operates by a three phase AC voltage which is applied from the motor controller 103 to generate a driving torque and operates as a generator when the vehicle is driven in a coasting mode to supply the regenerative energy to the battery 104.

The engine 108 outputs engine power in a starting-on state as a power source.

The second motor 109 is an electric motor which is also called a hybrid starter and generator (HSG) and operates as a starter and a generator of the hybrid vehicle.

The second motor 109 starts the engine 108 in accordance with a control signal which is applied from the hybrid controller 102 and operates as a generator while maintaining the engine 108 to be started on to generate a voltage and supplies the generated voltage to the battery 104 through the inverter 103 as a charging voltage.

The second motor 109 generates a starting torque in accordance with a control signal which converts the EV mode of the vehicle into the HEV mode to start the engine.

The engine clutch 110 is disposed between the engine 108 and the first motor 107 to drive the vehicle in the EV mode and the HEV mode.

The transmission 111 is configured by an automatic transmission (AT) or a multi range transmission such as a DCT and an engaging element and a disengaging element operate by operating hydraulic pressure in accordance with control of the engine clutch to engage a target gear.

As described above, the hybrid vehicle requires power coupling of the engine 108 and the first motor in order to satisfy a demand power of the driver and it is very important to determine a time to convert an EV mode into a HEV mode to improve drivability and fuel efficiency during this process.

Therefore, hereinafter, a method of calculating the system demand power by sum of a driver demand power and an electric load demand power in the vehicle by a hybrid controller 102 to determine a time to connect an optimal engine power according to an exemplary embodiment of the present invention will be described in detail.

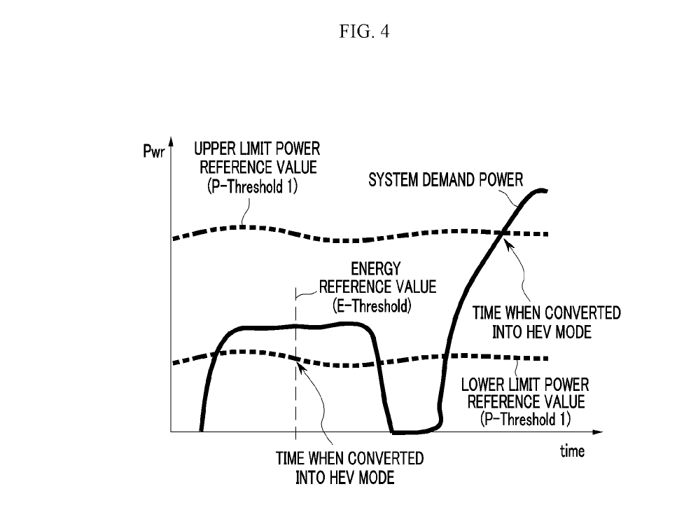

FIG. 4 illustrates a method of calculating a system demand power according to an exemplary embodiment of the present invention.

Referring to FIG. 4, a hybrid controller 102 calculates a driver demand power using an APS displacement mapping value by a pedal effort of a driver which presses an accelerator pedal while the vehicle is driven in an EV mode in step S101.

In this case, the hybrid controller 102 may calculate the drive demand power in consideration of the driver demand torque by an accelerator pedal effort and a rotation speed of the drive shaft.

Further, the hybrid controller 102 may calculate the driver demand power in consideration of a demand torque which is input for the automatic navigation control when the vehicle is controlled not by a pedal effort of the driver but by a feedback controller (not illustrated), such as cruise control or advanced smart cruise control, and a rotation speed of the driver shaft.

The hybrid controller 102 multiplies a weighting factor for every state of charge (SOC) of the battery 104 and the electric load consumption power such as an LDC, an air conditioner, a heater, and AVN to calculate the electric load demand power in step S102. Here, the weighting factor for every SOC may vary the system demand power such that when the current SOC is low, the system demand power is low and when a current charging state (SOC) is high, the system demand power is high.

The hybrid controller 102 calculates the system demand power by a sum of a driver demand power which is calculated by a mapping value by accelerator pedal manipulation information and the electric load demand power in step S103. The system demand power calculated as described above is used to determine whether to connect the engine power.

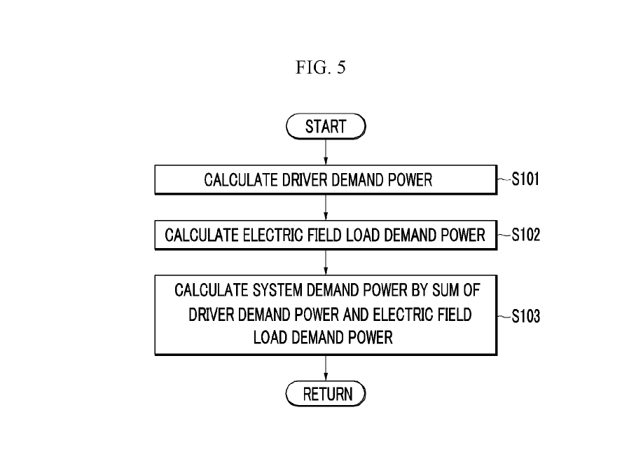

In the meantime, FIG. 5 is a graph illustrating a time to convert EV-HEV mode according to an exemplary embodiment of the present invention.

Referring to FIG. 5, the hybrid controller 102 sets a reference value for starting an engine by two values, i.e., an upper limit power reference value (P-threshold 1) and a lower limit power reference value (P-threshold 2) and compares the reference values with the system demand power to determine a time when the engine power is connected.

When the system demand power exceeds the set upper limit power reference value (P-threshold 1), the hybrid controller 102 controls to immediately shift the EV mode into the HEV mode. In this case, the hybrid controller 102 transmits a control signal which converts the EV mode of the vehicle into the HEV mode to the second motor 109, to start the engine.

Further, the hybrid controller 102 accumulates the system demand power to calculate accumulated demand energy in a low power demand condition where the system demand power exceeds the set lower limit power reference value (P-threshold 2). In addition, when the calculated accumulated demand energy exceeds a predetermined energy reference value (E-threshold), the hybrid controller 102 controls the mode to be shifted into the HEV mode.

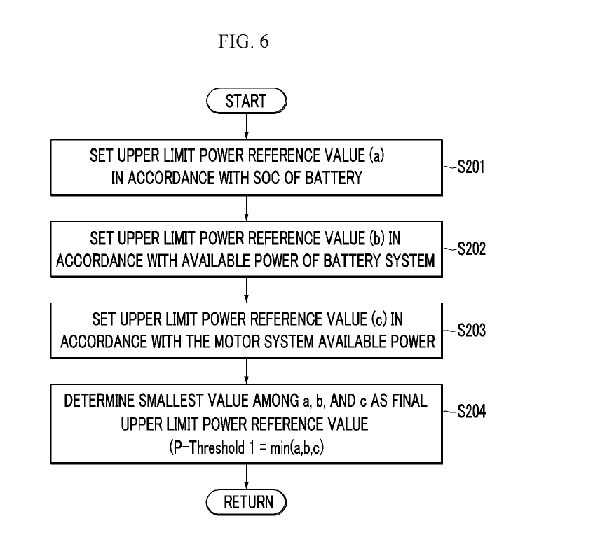

In the meantime, FIG. 6 illustrates a method for setting an upper limit power reference value according to an exemplary embodiment of the present invention.

Referring to FIG. 6, the hybrid controller 102 sets an upper limit power reference value (P-threshold a) in consideration of an SOC of the battery 104 in step S201.

In this case, the upper limit power reference value (P-threshold a) may vary in consideration of the SOC of the battery 104 such that as the current SOC is lower, the reference value is set to be lower and as the SOC is higher, the reference value is set to be higher.

That is, the hybrid controller 102 sets a shifting reference to the HEV mode to be lower as the SOC of the battery 104 is lower so that the engine power may be connected even in a system demand power which is small as compared with the usual SOC.

Further the hybrid controller 102 sets the upper limit power reference value (P-threshold b) in consideration of a maximum available power of the battery system in step S202 and sets the upper limit power reference value (P-threshold c) in consideration of the maximum available power of the first motor in step S203.

In this case, the available power of the battery 104 may be set in consideration of a battery temperature in accordance with a battery hardware specification, an SOC, and a margin for protecting a battery.

Further, the available power of the first motor 107 may be set in consideration of a motor inverter temperature in accordance with a hardware specification of the first motor and a margin for protecting the first motor.

The hybrid controller 102 determines the smallest value among the upper limit power reference value (P-threshold a) set in accordance with the SOC of the battery, the upper limit power reference value (P-threshold b) set in accordance with the maximum available power of the battery system, and the upper limit power reference value (P-threshold c) set in accordance with the maximum available power of the motor system as a final upper limit power reference value (P-Threshold 1) in step S204.

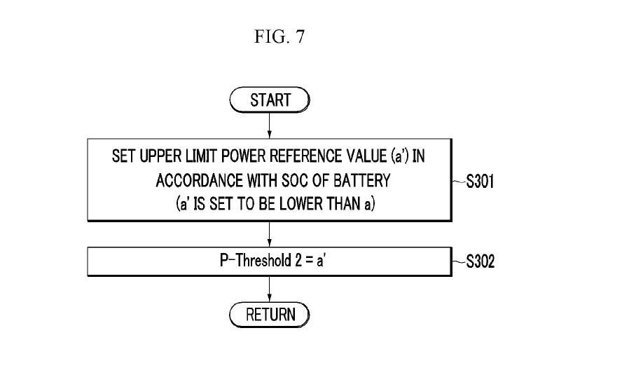

In the meantime, FIG. 7 illustrates a method for setting a lower limit power reference value according to an exemplary embodiment of the present invention.

Referring to FIG. 7, similarly to the above description, the hybrid controller 102 sets a lower limit power reference value (P-threshold a′) in accordance with the SOC of the battery and varies the set value in accordance with the current SOC state in step S301. However the lower limit power reference value (P-threshold value a′) in accordance with the SOC of the battery is set to be lower than the upper limit power reference value (P-threshold a) set in consideration of the SOC state. For example, the lower limit power reference value (P-threshold a′) may be mainly set based on a time when the accelerator pedal is pressed at an angle which is smaller than a predetermined angle like light tip in (LTI).

The hybrid controller 102 determines the lower limit power reference value (P-threshold a′) in accordance with the SOC of the battery as a final lower limit power reference value (P-threshold 2) in step S302.

In the meantime, the hybrid controller 102 may set an energy reference value (E-threshold) in consideration of the SOC of the battery 104 and similarly, the energy reference value is set to vary the set reference value to be low when the SOC of the battery 104 is low and to be high when the SOC of the battery 104 is high.

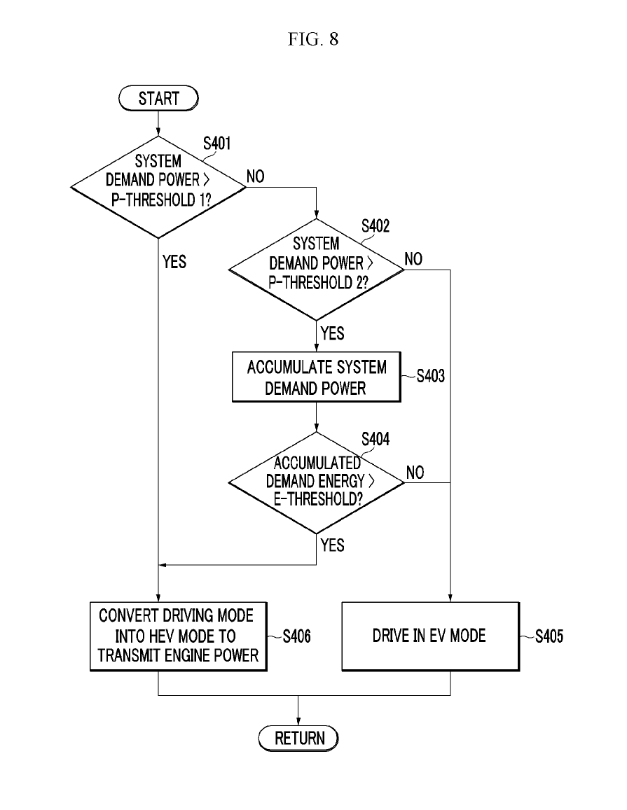

In the meantime, an EV-HEV mode conversion control method based on the configuration of the driving mode control system of a hybrid vehicle which has been described above will be described with reference to FIG. 8.

FIG. 8 is a flowchart illustrating a driving mode control method of a hybrid vehicle according to an exemplary embodiment of the present invention.

Referring to FIG. 8, a hybrid controller 102 according to an exemplary embodiment of the present invention sets a reference value for starting an engine by two values of an upper limit power reference value (P-threshold 1) and a lower limit power reference value (P-threshold 2) and it is assumed that the vehicle is driven in an EV mode.

First, the hybrid controller 102 calculates the system demand power by a sum of a driver demand power and an electric load demand power to compare the system demand power with the upper limit power reference value (P-threshold 1).

In this case, when the system demand power exceeds the upper limit power reference value (P-threshold 1) (Yes in step S401), the hybrid controller 102 controls to convert the EV mode into the HEV mode in order to immediately transmit the engine power in step S406.

In contrast, when the system demand power is smaller than the upper limit power reference value (P-threshold 1) (No in S401), but exceeds the lower limit power reference value (P-threshold 2) (Yes in S402), the hybrid controller 102 accumulates the system demand power to calculate the accumulated demand energy in step S403.

When the accumulated demand energy in which the system demand power is continuously accumulated while exceeding the lower limit power reference value (P-threshold 2) exceeds a predetermined energy reference value (E-threshold) (Yes in 404), the hybrid controller 102 controls to convert the EV mode into the HEV mode in order to transmit the engine power in step S406.

In contrast, in step S402, when the system demand power is smaller than the lower limit power reference value (P-threshold 2), (No in step S402), the hybrid controller 102 maintains the EV mode driving which is the present state in step S405.

Further, when the accumulated demand energy is smaller than the energy reference value (E-threshold) in step S404 (No in step S404), the hybrid controller 102 maintains the EV mode driving which is the present state in step S405.

As described above, according to the exemplary embodiment of the present invention, when the hybrid vehicle is continuously driven in a low driver demand condition, the mode is converted into HEV mode in accordance with accumulation of the system demand power, thereby preventing the high voltage battery from being over-discharged.

Further, differently from the related art in which it is simply determined that a low demand torque exceeds a predetermined reference time (a concept of the time is only presented and an exact value in view of energy is not reflected), it is determined whether to start the engine based on the practical demand energy so that it is advantageous in balancing the SOC of the high voltage battery.

The exemplary embodiment of the present invention is not implemented only by way of an apparatus and a method described above, but may be implemented by a program which executes a function corresponding to the configuration of the exemplary embodiment of the present invention or a recording medium in which the program is written and those skilled in the art may easily implement the exemplary embodiment of the present invention from the description of the exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving mode control system of a hybrid vehicle, the system comprising:
a driving information detecting unit which detects information of manipulation of an accelerator pedal by a driver when the hybrid vehicle moves and an operating state of an electric load;
a second motor which generates a starting torque in accordance with a control signal which converts a driving state into a hybrid electric vehicle (HEV) mode to start the engine; and
a hybrid controller which calculates a system demand power by a sum of a driver demand power which is calculated by a mapping value by the accelerator pedal manipulation information and the electric load demand power in accordance with the operating state of the electric field load to determine a time to connect the engine power in accordance with a predetermined reference value setting,
wherein when the system demand power exceeds a set upper limit power reference value (P-threshold 1), the hybrid controller controls to convert a driving mode into the HEV mode, and in a low power demand condition where the system demand power exceeds a lower limit power reference value (P-threshold 2), when an accumulated demand energy in which the system demand power is accumulated exceeds a predetermined energy reference value (E-threshold), convert the driving mode into the HEV mode.

2. The system of claim 1, further comprising:
an inverter which drives a first motor and the second motor which convert a DC voltage supplied from a battery into an AC voltage to generate a driving torque;
a battery management unit which manages a state of charge (SOC) of the battery; and
an engine controller which controls the engine torque in accordance with a command of the hybrid controller and monitors an operating state of the engine to transmit the operating state to the hybrid controller.

3. The system of claim 1, wherein:
when the hybrid vehicle is feedback controlled by cruise control, the hybrid controller calculates the driver demand power in consideration of a demand torque which is input for automatic navigation control and a rotation speed of a drive shaft.

4. The system of claim 1, wherein:
the hybrid controller multiplies a weighting factor for every state of charge (SOC) of the battery and consumption power of electric equipment in the hybrid vehicle including at least one of an air conditioner, a heater, an AVN, and an LDC to calculate the electric load demand power.

5. The system of claim 4, wherein:
the weighting factor for every SOC of the battery varies the system demand power such that when the SOC of the battery is low, the system demand power is low and when the SOC is high, the system demand power is high.

6. The system of claim 1, wherein:
the hybrid controller sets the upper limit power reference value in consideration of a state of charge (SOC) of a battery, a maximum available power of the battery, and an available power of a first motor to set the upper limit power reference value and determines a minimum value among multiple power reference values as the upper limit power reference value (P-threshold 1).

7. The system of claim 6, wherein:
when the hybrid controller sets the upper limit power reference value in consideration of the SOC of the battery, the hybrid controller sets the reference value to be low as the current SOC state is low and sets the reference value to be high as the SOC is high.

8. The system of claim 6, wherein:
the available power of the battery is set in consideration of a battery temperature in accordance with a battery hardware specification, the SOC, and a margin for protecting a battery, and
the available power of the first motor is set in consideration of a motor inverter temperature in accordance with a hardware specification of the first motor and a margin for protecting the first motor.

9. The system of claim 6, wherein the lower limit power reference value is set by varying the set value in accordance with the SOC of the battery and set to be lower than the upper limit power reference value in consideration of the SOC.

10. The system of claim 6, wherein:
the lower limit power reference value is set based on a time when the accelerator pedal is pressed at an angle which is smaller than a predetermined angle of light tip in (LTI).

11. The system of claim 1, wherein:
the accumulated demand energy is a value which is accumulated while the exceeded state is maintained from a time when the system demand power exceeds the lower limit power reference value (P-threshold 2).

12. The system of claim 1, wherein:
the energy reference value is set by varying the set reference value to be small when the SOC of the battery is small and to be high when the SOC is high.

13. A driving mode control method of a hybrid vehicle which is driven in an electric vehicle (EV) mode in which a reference value for starting an engine is set by two values, an upper limit power reference value (P-threshold value 1) and a lower limit power reference value (P-threshold 2), the method comprising:
a) calculating a system demand power by a sum of a driver demand power calculated by a mapping value by accelerator pedal manipulating information of a driver and an electric load demand power in accordance with an operating state of an electric load;
b) controlling the driving mode to be converted into a hybrid electric vehicle (HEV) mode when the system demand power exceeds the upper limit power reference value (P-threshold 1); or
c) accumulating the system demand power in a low power demand condition where the system demand power is smaller than the upper limit power reference value but exceeds the lower limit power reference value (P-threshold 2); and
d) controlling the driving mode to be converted into the HEV mode when the accumulated demand energy in which the system demand power is accumulated exceeds a predetermined energy reference value (E-threshold).

14. The method of claim 13, further comprising:
before step a),
determining the smallest value among a first upper limit power reference value (P-threshold a) set in accordance with a charging state (SOC) of a battery, a second upper limit power reference value (P-threshold b) set in accordance with a maximum available power of the battery system, and a third upper limit power reference value (P-threshold c) set in accordance with the maximum available power of the first motor as a final upper limit power reference value (P-threshold 1); and
setting the lower limit power reference value in accordance with the SOC of the battery, to be lower than the first upper limit power reference value in consideration of the SOC.
